(19) United States
(12) Patent Application Publication
(10) Pub. No.: US 2006/0229054 A1
(43) Pub. Date: Oct. 12, 2006

(54) Help desk connect

(76) Inventors: Esa Erola, Kauniainen (FI); Patrik Gustafsson, Esbo (FI); Vesa Luiro, Oulu (FI); Harry Santamaki, Helsinki (FI)

Correspondence Address: Hollingsworth & Funk, LLC, Suite 125, 8009 34th Avenue South, Minneapolis, MN, 55425, US

(21) Appl. No.: 11/101,373

(22) Filed: Apr. 7, 2005

(51) Int. Cl. H04Q 7/20

(52) U.S. Cl. 455/403; 455/445

(57) ABSTRACT

Providing assistance to a user of a mobile device involves sending a signal from the mobile device to a help service computing arrangement via a network to initiate a help session. Device-specific data of the mobile device is sent via the network and targeted for a help database. A session identifier is associated with the device-specific data via the help service computing arrangement. A voice connection between the user and a help agent is established and the session identifier is provided to the help agent. The device-specific data is accessed by the help agent from the help database using the session identifier for purposes of providing the assistance.

### FIELD OF THE INVENTION

This invention relates in general to communications networks, and more particularly to providing help services via data and voice communication networks.

### BACKGROUND OF THE INVENTION

Mobile communications devices such as cell phones are gaining wide acceptance. The popularity of these devices is due their portability as well as the advanced features being added to such devices. Modern cell phones and related devices offer an ever-growing list of digital capabilities. For example, many phones may be equipped with software that allows the devices to provide customized network services for the benefit of users.

Of particular importance to mobile users is the ability to obtain help for various technical and non-technical matters relating to the mobile devices and network services related to the devices. As the phones and network service become ever more complex, it will be vital that users be provided with help services that may include any combination of digital resources and assistance from help professionals.

One problem in providing help to computer users is gathering of data needed to resolve problems. Such data may include hardware and software configurations, user identities, service account numbers, and other data related to a particular problem. This problem is particularly acute when trying to troubleshoot a problem with a mobile device, because the device may serve both as the voice link with the help desk, as well as the computing device that contains the needed data. In such a case, the user may have to repeatedly break away from the conversation to manipulate the user interface to look up the needed data. In the worst case, the user may not even be able to view the screen at the same time as talking, forcing the user to remember or write down the data before communicating it to the help service agent.

Therefore, a way of providing help services to computer users particularly mobile device users) that provides easier access to help data is desired. Such a help service should be relatively easy to operate yet provide detailed data useful in resolving help transactions.

### SUMMARY OF THE INVENTION

The present disclosure relates to providing help services to mobile device users via communications networks. In accordance with one embodiment of the invention, a method of providing assistance to a user of a mobile device involves sending a signal from the mobile device to a help service computing arrangement via a network to initiate a help session. Device-specific data of the mobile device is sent via the network targeted for a help database. A session identifier is associated with the device-specific data via the help service computing arrangement. A voice connection is established between the user and a help agent, and the session identifier is provided to the help agent. The help agent accesses the device-specific data from the help database using the session identifier for purposes of providing the assistance.

In more particular embodiments, the method involves the help agent forming a network-accessible document for purposes of providing the assistance. The mobile device then accesses the document by via the network. The mobile device may receive a network location identifier sent by the help service computing arrangement via the network in response to the signal, so that sending the device-specific data to the help database involves sending the device specific data to the network location identifier.

In other, more particular embodiments, the method involves receiving at the mobile device the session reference identifier from the help service computing arrangement via the network in response to the signal. The mobile device may also receive a data descriptor from the help service computing arrangement via the network in response to the signal. The data descriptor describes the device-specific data needed to provide the assistance.

In other, more particular embodiments, providing the session identifier to the help agent involves appending the session identifier to a phone number used to initiate the voice connection. Associating the session identifier with the device-specific data may involve associating any combination of a network address and a Mobile Station Integrated Services Digital Network number (MSISDN of the mobile device with the device-specific data. Providing the session identifier to the help agent may involve determining the MSISDN in conjunction with establishing the voice connection between the user and the help agent. The MSISDN may be determined using a caller line identification service, and/or by appending the MSISDN to a phone number used to initiate the voice connection.

In other, more particular embodiments, the mobile device receives a help service phone number from the help service computing arrangement via the network in response to sending the signal from the mobile device to the help service computing arrangement and/or in response to sending the device-specific data of the mobile device targeted for the help database. The mobile device may receive an update to the help service phone number from the help service computing arrangement via the network in response to sending the device-specific data of the mobile device targeted for the help database. Initiating the voice connection between the user and the help agent may involve automatically dialing the help service phone number via a processor of the mobile terminal to initiate the voice connection between the user and the help agent.

In another embodiment of the present invention, a data-processing arrangement includes a network interface capable of receiving data via a network. The arrangement includes a voice communications module that is capable of being coupled to a voice network. A processor is coupled to the network interface and the voice communications module. Memory is coupled to the processor and includes a help application that causes the processor to send a signal to a help service computing arrangement via the network to initiate a help session. Device-specific data of the data-processing arrangement is sent via the network targeted for a help database. A session identifier associated with the device-specific data is received from the help service computing arrangement. A voice connection with a help agent is initiated via the voice communications module, and the session identifier is provided to the help agent purposes of retrieving the device-specific data for providing assistance.

In a more particular embodiment, the data processing arrangement includes a database module that causes the processor to access the device-specific data. The help application is further configured to cause the processor to obtain the device specific data from the database module before sending the device-specific data targeted for the help database. The help application may be further configured to cause the processor to receive a data descriptor from the help service computing arrangement via the network in response to the signal. The data descriptor is used to obtain the device-specific data from the database module.

In another, more particular embodiment, the data processing arrangement includes a telephony connection module coupled to the voice communication module and the processor. The help application is further configured to cause the telephony connection module to dial a help service phone number to initiate the voice connection with the help agent. The telephony connection module may be configured to dial the help service phone number appended with the session identifier to initiate the voice connection with the help agent.

In another embodiment of the present invention, a processor-readable medium has stored instructions which are executable by a data processing arrangement capable of being coupled to a network. The instructions are executable by the data processing arrangement for performing steps involving: sending a signal to a help service computing arrangement via the network to initiate a help session; sending device-specific data of the data-processing arrangement via the network targeted for a help database; receiving a session identifier associated with the device-specific data from the help service computing arrangement; initiating a voice connection with a help agent; and providing the session identifier to the help agent purposes of retrieving the device-specific data for providing assistance.

In another embodiment of the present invention, a data-processing arrangement includes a network interface capable of communicating via a network. A processor is coupled to the network interface, and memory is coupled to the processor. The memory has a help service module that causes the processor to receive a signal from a mobile device to initiate a help session via the network. A trigger is sent to the mobile device in response to the signal. The trigger is configured to cause the mobile device to send device-specific data of the mobile device to a help database via the network. A session identifier is associated with the device-specific data and access of the device-specific data from the help database is provided. The session identifier is used for purposes of providing assistance to a help agent conducting a telephonic help session.

In another embodiment of the present invention, a processor-readable medium has stored instructions which are executable by a data processing arrangement capable of being coupled to a network. The instructions are executable by the data processing arrangement for performing steps involving: receiving signal from a mobile device to initiate a help session via the network; sending a trigger to the mobile device in response to the signal, the trigger configured to cause the mobile device to send device-specific data of the mobile device to a help database via the network; associating a session identifier with the device-specific data; and facilitating access of the device-specific data from the help database using the session identifier for purposes of providing assistance to a help agent conducting a telephonic help session.

In another embodiment of the present invention, a system includes: means for sending a signal from a mobile device to a help service computing arrangement to initiate a help session; means for sending device-specific data of the mobile device to a help database; means for associating a session identifier with the device-specific data; means for initiating a voice connection between the user and a help agent; means for providing the session identifier to the help agent; and means for accessing the device-specific data by the help agent using the session identifier for purposes of providing the assistance.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating a system environment in which in which various embodiments of the invention may be practiced;

FIG. 2 is a block diagram of a more particular mobile communications system environment in which in which various embodiments of the invention may be practiced;

FIG. 3 is a block diagram illustrating an example help center system environment in which in which various embodiments of the invention may be practiced;

FIG. 4 is a sequence diagram illustrating help service transactions between network entities according to embodiments of the present invention;

FIG. 5 is a sequence diagram illustrating alternate help service transactions between network entities according to embodiments of the present invention;

FIG. 5A is a block diagram of a customer relations transaction according to embodiments of the present invention;

FIG. 6 is a block diagram of a mobile device capable of engaging in help service transactions according to embodiments of the present invention;

FIG. 7 is a block diagram of a network service elements capable of engaging in help service transactions according to embodiments of the present invention;

FIG. 8 is a flowchart illustrating an example procedure for providing help services to a mobile device according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to providing help desk services to mobile device users. In one scenario, a mobile device user is able to initiate a help transaction via a Web browser or other networking software residing on the mobile device itself. The transaction may involve transferring user and/or device data to a network service element for use by a help desk agent. The device data may be needed by the help desk agent to resolve the problem. The transaction may also involve automatic determination of an appropriate telephone number for purposes of initiating voice contact with a help desk agent. Thereafter, a help desk service call can commence, and the help desk agent may have one or more ways of accessing the device data during the call. Typically, the help desk agent accesses the device data accessed via a network-coupled database.

The help desk agent provides support during the call based on the device data. The help desk support may include creating a custom Web page for the benefit of the mobile device user. Once the call is complete, the device user can access the Web page for information, links, software, and other automatic help mechanisms known in the art. The Web page may include links used for subsequent actions to be taken by the user. The user may browse these links, use them for downloading content (e.g., documents, software, ring tones), or to initiate a device management session. Such management sessions may help the user either manually or automatically to update device software or configure the mobile device.

Although the term “help desk service” generally refers to technical or account support, it will be appreciated that this term can be applied to any situation where a user seeks advice via the telephone. Generally, any use that involves sending computerized data to a person on the other end of a voice connection may apply the concepts described herein. For example, an e-commerce Web site may allow a user to place an order via telephone or discuss further transactions with a sales department. Instead of requiring the caller to tediously recite relevant information over the phone, the Web site allows certain data stored on the mobile device to be sent to a server that is accessible by the sales department. In response, a phone number of a nearby service agent can be transmitted to the mobile device and used to place the call.

The sales agent's phone number may be automatically determined based on locality, language, subject of call, and other relevant data. Once in contact with the sales agent, an identifier of the transaction can be manually or automatically provided to the agent in order to retrieve the mobile device data to be accessed at the server. The sales agent can access this data to quickly, accurately, and easily complete the transaction.

One particular piece of device data that may be useful in the sales context is the Web page that the user was accessing before initiating the help transaction. The user may have entered data (e.g. name, address, chosen product features, size of the order etc.) on this page before the call in order to accelerate the call. The system may have mechanisms the enable the user to add his her contact info (e.g., digital business card) from the phone directory easily to the field of the page. This data may be useful for closing a business transaction over the phone and for giving further advice to customer. The precondition of filling in data on the page can be part of a customer service help session, in order to check what the user already knows about the problem.

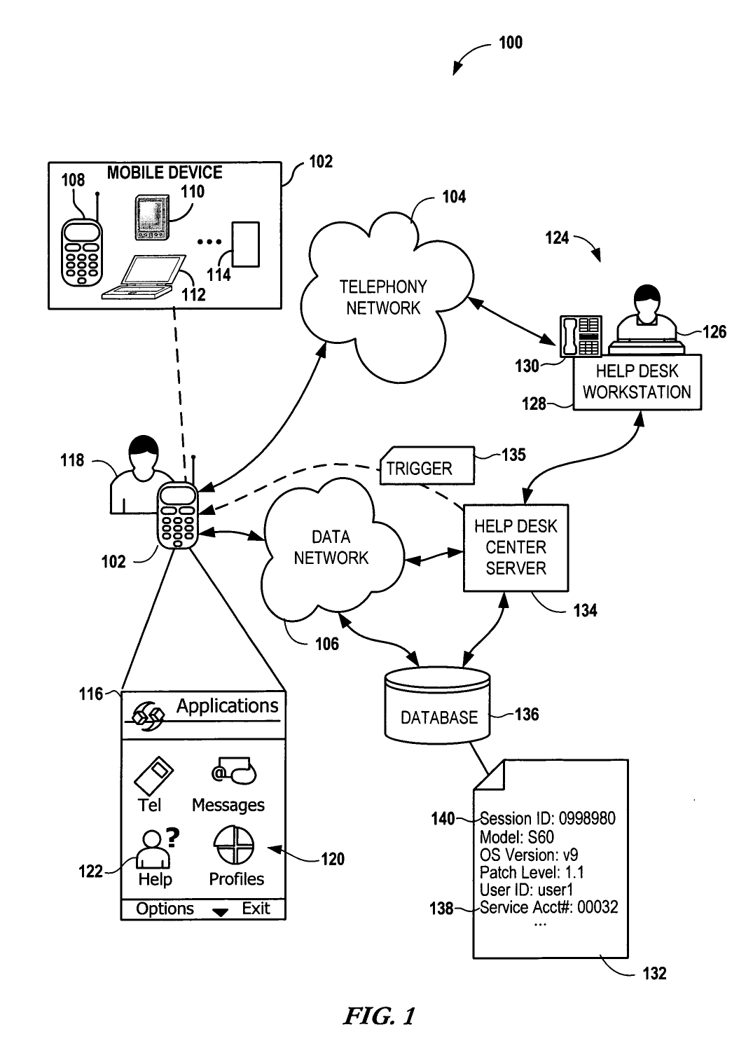

Referring now to FIG. 1, a network environment 100 is illustrated in which various embodiments of the invention may be practiced. Generally, the invention involves at least one mobile device 102 that may be coupled to a telephony network 104 and/or a data network 106. The telephony network 104 and data network 106 may be entirely separate, or may share various infrastructure components. For example, both networks 104, 106 may be part of a Global System for Mobile Communications (GSM) General Packet Radio Service (GPRS) network that may provide both circuit-switched voice and packet-switched data services. In another example, the telephony network 104 may be part of a cellular voice network, but the service of the data network 106 may be provided by a local area network such as an 802.11 wireless network access point. The concepts described herein may be applicable to any combination of telephony and data networks 104, 106 now known or later developed.

Any portable data communications apparatus known in the art may be used as the mobile device 102, including a cellular phone 108, Personal Digital Assistant (PDA) 110, laptop/notebook computer 112, or other device as represented by generic device 114. The mobile device 102 may be coupled to the telephony and data networks 104, 106 through any combination of wired and wireless communication mediums. The mobile device 102 may be enabled to communicate with the telephony and data networks 104, 106 simultaneously. It will be appreciated, however, that the concepts described herein may also work with mobile devices 102 that can maintain only one of a voice or data connection at a given time.

The mobile device 102 may contain a user interface such as a Graphical User Interface (GUI) 116. The GUI provides a user 118 of the device 102 with the ability to visually and physically interact with the device 102 for purposes of indicating status, enabling device control, accessing content, and the like. The mobile device 102 may contain the ability to run one or more applications 120. These applications 120 may include processor readable instructions that are stored on the device or accessible via external communications links. In the illustrated example, the applications 120 are accessed by selecting icons in the GUI 116.

One of the applications 120 usable by the device is a help application 122. The help application 122 may be accessed as an icon, menu item, a command-line command, a Web page link, a browser bookmark, etc. Although for purposes of discussion, it may be assumed that the help application 122 is an independently running software program, it will be appreciated that the help application 122 may be configured as any combination of program, hyperlink, bookmark, operating system feature/service, library, daemon, script, embedded object, or any other programming construct known in the art. For example, the help application 122 may initially comprise a link on a Web page. When activated, the link allows the user to download and install a client software program that performs at least part of the help application functionality.

The user 118 activates the help application 122 whenever the user 118 seeks the assistance of a help agent 124. The help agent 124 may provide any type of support to the user, including technical support, billing/account support, product queries, sales, scheduling, dispatching, and many other tasks that may require the assistance of a person or knowledge base. The help agent 124 typically includes a person 126, although in some applications automated help agents 124 may be used, such as expert systems utilizing voice recognition and voice synthesis. The help agent 124 typically has simultaneous access to a data workstation 128 and a voice communications device such as a telephone 130. The data workstation 128 can be used to access data to support the help agent 124.

The help agent 124 usually will require some sort of device-specific data 132 in order to provide service. In typical help service systems, the user 118 may provide at least some of this data 132 to the agent 124 verbally during the call. Often, the help agent 124 may obtain other parts of the data 132 via a help desk center server 134 and/or a database 136. For example, the user 118 may provide a service account number 138, and the help agent 124 uses this number 136 as a key to access account data via the database 136.

In some cases, the user 118 may have to provide a significant amount of data to the help desk agent 124. This data may be needed in order to provide assistance, to verify identity, and/or due to corporate policies that require checking the accuracy and currency of certain account data (e.g., address, phone number). The data may include hardware identifiers such as an International Mobile Equipment Identity (IMEI). The IMEI is a unique number given to every mobile phone, and used for determining whether the phone is authorized to join a GSM network. Other hardware identifiers may include processor IDs, Media Access Control (MAC) addresses, removable media identifiers, etc. The data provided to the help desk agent 124 may also include software identifiers such as name and version of the operating system, patch levels, installed modules and programs, currently running processes, active services/daemons, user profiles, dynamically allocated network addresses, etc.

It will be appreciated that providing a large amount of data via the telephony network 104 is problematic. Verbal communications are time consuming, insecure (e.g., eavesdropper can get account numbers), prone to inaccuracy, annoying to the user 118, and often repetitious (e.g., when agent 124 hands user 118 over to another expert, and user 118 has to repeat some data to the expert). It may also be non-trivial for the user to access data such as hardware and software identifiers, which may require navigation through many menus and dialogs of the GUI 116.

To solve the problem of requiring the user 118 to provide device-specific data 132 verbally, the system 100 can be configured to provide most or all of the device-specific data 132 via the data network 106. Instead of first dialing a phone number of a help facility, the user 118 instead launches the help application 122. The help application 122 may be a full-blown application program, or may be a Uniform Resource Locator (URL) associated with the help service. The help application 122 sends a request to the help desk center server 134. The help application 122 may insert special headers in the request so that the help desk center server 134 can recognize that the help application 122 is making the request, as opposed to a generic browser request. If the help desk center server 134 determines that the request is not from the correct application 122, the server 134 may respond with a document informing the user 118 they may not proceed.

If the server 134 receives a properly formed request from the application 122, the server 134 responds by sending a trigger 135 to the mobile device 102. The trigger 135 may be any type of message or document containing data that furthers the help session. The trigger 135 may include a network location identifier such as a Uniform Resource Locator (URL) to which the mobile device 102 may upload the data 132. The trigger 135 may also include a session reference identifier 140 that is associated with any device specific data sent from the mobile device 102. The mobile device 102 can use the session reference identifier as a unique identifier related to any further transactions associated with the help session.

The help application 122 may require a way to determine the particular device data 132 needed to fulfill the help request. The trigger 135 may include a descriptor of the device data 132. For example, if the help request is in relation to an application bug, the descriptor may request a description of the software installed, operating system version, etc. If such a descriptor is provided, the help application 122 may use the descriptor to gather the device-specific data from the device 102. Otherwise, the help application 122 may have a predetermined set of data associated with various help requests.

After the data 132 is gathered, the help application 122 may prompt the user 118 for permission to send the device-specific data 132. If the user 118 approves, the data 132 may be sent to the URL provided in the trigger 135. The data 132 is then stored in the database 136, where the session reference identifier 140 may be used as a key to access the data 132.

After the mobile device 102 has sent the data 132, the server 134 may provide the device 102 with a telephone number of an appropriate help agent 124. The telephone number may be selected based on the help service requested, as well as other appropriate device/user data (e.g. network code, country code, etc.). The telephone number may be an update to an existing telephone number (e.g., a number provided in the trigger 135), and/or the server 134 may provide a list of numbers to choose from. The telephone number may be a standard PSTN number, or an address used for alternate voice communications such as VoIP. The address may be a public network address (e.g., an IP address), or a private address space (e.g., Skype).

After receiving a phone number or address, the device 102 can automatically connect using the number/address upon approval by the user 118. When the agent 124 answers the call, the agent 124 is provided with the session reference identifier 140 and proceeds to access the data 132 via the call center server 134 and/or database 136. The agent 124 then has the facts needed to analyze the problem, and can provide a solution verbally to the user 118.

In addition to verbal assistance, the agent 124 may also provide a more detailed response to the user in the form of a Web page or other electronic document. Upon completion of the call, the user 118 can access a link via the help application 122 or browser (not shown), and thereafter view the solution, save it for later reference, print it, use it to conduct follow-on activities, and generally use the solution like any other document. In other arrangements, the device 102 may include server software that allows the agent 124 to remotely access the device 102 either during or after the call. Such software may allow the agent 124 to interactively make changes, such as modifying/adding software, setting configurations, etc.

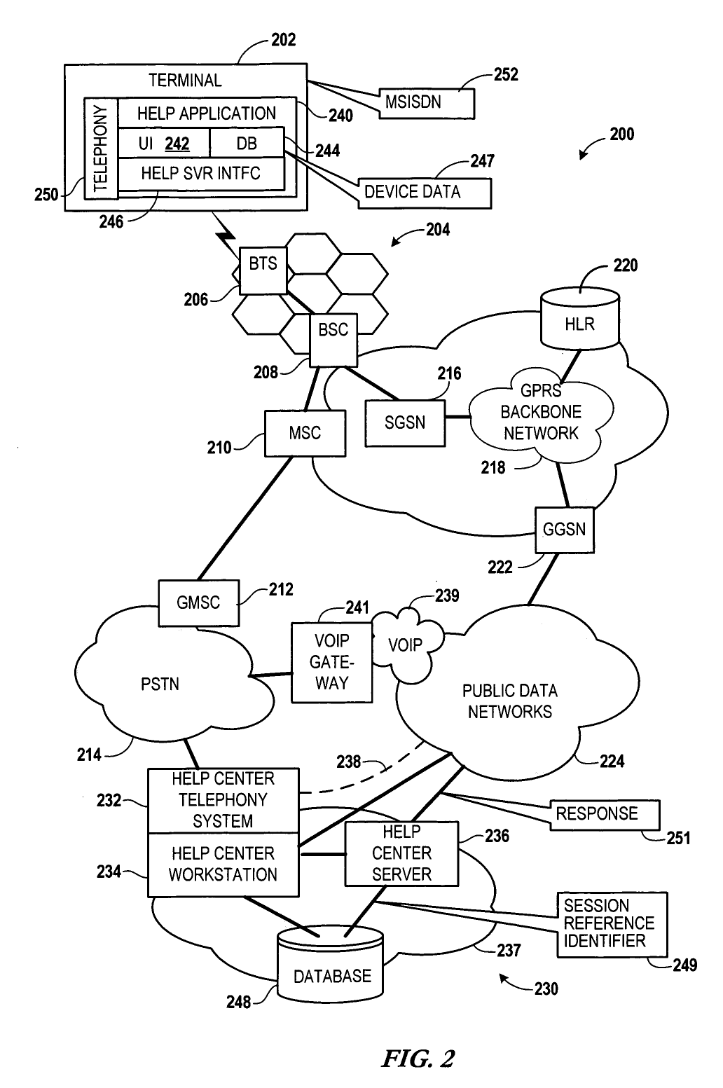

The system described in relation to FIG. 1 may be implemented in all maimer of mobile communications networks using a wide variety of devices. A more particular example of a help access system implemented in a mobile communications network according to an embodiment of the invention is shown in FIG. 2. The help access system shown in FIG. 2 is implemented in a GSM/GPRS environment 200. GPRS provides packet radio access for mobile GSM and time-division multiple access (TDMA) users. GPRS allows network operators to implement an IP-based core architecture for data applications. This core architecture can expanded to provide third generation (3G) integrated voice and data applications to users of a GPRS enabled terminal 202.

The terminal 202, also commonly referred to as a mobile station (MS) and/or user equipment (UE), is capable of connecting to the network environment 200 via a cellular radio network 204. The radio network 204, also referred to as a base station subsystem (BSS), includes at least one base transceiver station (BTS) 206 and a base station controller (BSC) 208, The BTS 206 includes radio equipment necessary for radio transmission within a geographical area, or cell. The BTS is responsible for establishing the radio link to the terminal 202. The BSC 208 is the controlling component of the radio network 204, and typically manages multiple BTSs 206.

The radio network 204 can provide both packet-switched and circuit switched data services to the terminal 202. The circuit switched data traffic (usually voice communications) is handled by a mobile switching center (MSC) 210. The MSC 210 is an Integrated Services Digital Network (ISDN) switch that sets up connections to the BSC 208 to other MSCs. A plurality of MSCs 210 form a fixed backbone of a GSM network and can switch calls to a gateway MSC (GSMC) 212. The GMSC 212 provides the gateway to the public switched telephone network (PSTN) 214.

The radio network 204 provides packet-switched data services via a Serving GPRS Support Node (SGSN) 216. The SGSN 216 exchanges packets between the GPRS backbone network 218 and terminals 202 within the service area of the SGSN 216. The SGSN 216 is able to detect new GPRS terminals 202 as they connect to a given service area. The SGSN 216 performs mobility management functions such as handing off a roaming subscriber from the equipment in one cell to the equipment in another. The SGSN 216 also processes registration of new mobile subscribers and keep records of the subscriber's locations inside a predefined area. The SGSN 218 is able to maintain profile data of GPRS subscribers by accessing home location registers (HLRs) 220.

The terminal 202 is able to connect to outside networks via a Gateway GPRS Support Node (GGSN) 222. The GGSN 222 is used as an interface to public data networks 224 such as the Internet, other mobile service providers' GPRS services, or enterprise intranets. The GGSN 222 allows the terminal 202 to connect to nodes of the public data networks 224 using standard protocols such as the Internet Protocol (IP) and X.25. This enables software applications running on the terminal 202 to utilize the vast amount of data services available via the public data networks 224, including email, Web browsing, Internet relay chat (IRC), peer-to-peer file sharing, etc.

In the illustrated environment 200, a help service center 230 may be implemented independently of the packet and circuit switched networks of the mobile terminal service provider. In the illustrated example, the help service center 230 includes a telephone system 232 coupled to the PSTN 214. A help center workstation 234 and server 236 are coupled to a local network 237, which may in turn be coupled to the public data networks 224 by devices such as routers and firewalls (not shown).

Although the illustrated help service center 230 is shown receiving voice via the PSTN 214 and data via the public data networks 224, the help service center 230 may obtain voice or data connectivity using any of the illustrated networks. For example, where the help service is provided by a cellular service provider, the help service center 230 may connect directly into the GPRS backbone network 218 without utilizing public data networks 224. In another arrangement, the voice communications of the help service center 230 may be provided, in whole or in part, by the public data network 224, as represented by path 238. In this latter arrangement, technologies such as Voice over IP (VoIP) 239 can be used provide telephony services over packet switched data networks 224.

Generally, VoIP 239 a technology that allows users to make telephone calls using a Internet connections instead of or in addition to the PSTN 214. Some VoIP services 239 may only allow connections between the machines within the domain of the public data networks 224. Other VoIP services 239 allow connections to the PSTN 214, such as through a VoIP gateway 241. Some VoIP services 239 only work over a computer or a special VoIP phone, while other services VoIP services 239 allow the use of a traditional phone through an adaptor.

In order to obtain help from the help service center 230, the terminal 202 may include a help application 240. The help application 240 may be configured as a program component, standalone application program, operating system service, or other programmatic construct. The help application 240 may also be integrated with an existing application or service. For example, the help application 240 may be provided as a browser plug-in, so that the application 240 is used to extend the functionality of an existing Web browser program in order to provide help center services.

The help application 240 will typically have a user interface (UI) component 242 for providing user feedback and for accepting user inputs. A database component 244 may be used for collecting, storing, and managing user and device data provided by the help application 240. The database component 244 may use any combination of persistent and non-persistent memory to store and arrange user data. For example, the help application 240 may gather various settings, preferences, and identifiers stored in non-volatile memory of the device (e.g., flash memory or hard drive) or accessible directly from hardware (e.g., media access control address of a network card). The help application 240 may also prompt the user for further information, which may be stored be stored temporarily in non-volatile memory (e.g., random access memory).

The UI 242 and database components 244 operate in conjunction with a help server interface 246. The help server interface 246 contains the logic needed to interact via data networks 218, 224 with help center entities such as the help center server 236. The help server interface 246 may utilize custom, proprietary protocols in communicating with the help service center 230, as well as standardized protocols. As an example of the latter types of protocols, the interface 246 may communicate with the help server interface using Hypertext Transfer Protocol (HTTP) or HTTP over Secure Sockets Layer (HTTPS). The combination of HTTP/HTTPS on top of Transmission Control Protocol/Internet Protocol (TCP/IP) is mature, reliable, and adaptable to many different end uses.

Generally, the user interacts with the help application 240 when the user has a technical problem or otherwise desires information from a help agent. The application 240 can be activated via the operating system of the terminal, such as by launching a process or clicking a link on a Web page. After activation, the application 240 may cause the UI 242 to prompt the user for information. For example, the UI 242 may present a form allowing the user to choose the category of help desired and/or a detailed description of the help desired. Such a form may be provided locally or remotely. As an example of the latter, the form may be included in a Hypertext Markup Language (HTML) document that originates from the help center 230. When the user activates the application 240, the help server interface 246 may signal (e.g., using an HTTP GET) to a predetermined server that a help service is requested. In response, the predetermined server responds with an HTML document and a URL for submission of user data 247 upon completion of the form.

The UI 242 may require the user to fill in some data into the help form. Depending on the category of help selected, the UI 242 may present some parts of the form pre-filled with data 247 that is stored locally on the terminal 202. This data 247 may be collected via the database component 244. Presenting the data 247 to the user before submission informs the user of what data is being submitted and provides the user an opportunity to verify the accuracy of the information. For example, contact information (e.g., phone numbers, addresses) may be needed in some situations. Because user contact information is subject to change over time, the user may be prompted via the UI 242 to verify the information is current. This also provides the user with the opportunity to cancel or edit the transaction should the user not wish to divulge this information. It will be appreciated, however, that the data 247 may be selected for use in the help query without showing any of the data 247 to the user.

After the data 247 used in the help query is collected, the UI 242 may provide some interface element (e.g., a “send” button) to initiate the help transaction. This may involve making an HTTP connection with a well-known URL, such as might be associated with the help center server 236 or proxies associated with the server 236. Alternatively, the URL of the help center server 236 may have been provided during the initial signaling by a predetermined help center entity. Sending the data 247 may involve an HTTP POST or HTTP GET directed towards the help center server 236. If the user data 247 was entered at the UI 242 using HTML forms, this form data can be transmitted to the server 236 using standard mechanisms associated with HTML form data submission.

It will be appreciated that the user data 247 may contain information that the user wants to keep private. Therefore, the help server interface 246 may include features that only allow the data to be submitted to trusted sites. For example, the help server interface 246 may institute a URL connection policy that the data 247 may only be submitted to a particular, trusted domain (e.g., “help-portal.com”). The help server interface 246 may also utilize Public Key Infrastructure (PKI) certificates or the like to authenticate the identity of the help center server 236. Additionally, the data 237 may be encrypted (e.g., PKI, shared private keys, Virtual Private Networking over Secure Sockets Layer) to prevent the data from being read in transit by unauthorized third parties.

Upon receipt of the user data 247, the help center server 236 may store the data 247 in a database 248. The database 248 may be any combination of files, relational databases, object databases, etc. Generally, the database 248 allows storage and retrieval of data. The database 248 is designed for the efficient categorization and retrieval of stored data, and may be part of the help center server 236 or may run independently. The database 248 and/or help center server 236 may generate and/or associate a session reference identifier 249 with the stored data 247 received from the terminal 202.

Once the device's data 247 is stored, the help center server 236 may provide a response object 251. This response object 251 may be a standard HTML document formatted for display in the application's UI 242. The response object 251 may provide data that furthers the help service call, including the session reference identifier 249 and a phone number of the appropriate help center telephone system 232. The help server interface 246 may programmatically access this response object 251 in order to provide additional automated functions. For example, the response object 251 may contain computer-readable instructions used to automatically dial the help center phone number via a telephony module 250 of the terminal 202.

Once the phone call has been placed to the help service center 230, the session reference identifier 249 will be provided to the help service agent. This identifier 249 may be provided in a number of ways. The user of the terminal 202 may verbally recite the identifier 249 to the help desk agent, who then enters the identifier 249 into an application on the help center workstation 234. The workstation 234 can query the help center server 236 and/or database 248 to retrieve the data that was previously stored therein by the terminal 202.

Although verbally providing the session reference identifier 249 to the help service agent may be easily implemented, it may be occasionally inaccurate or inconvenient. Therefore, the help server interface 246 may be further configured to automatically provide the session reference identifier 249 to the help service agent via the telephony module 250. For example, when the telephony module 250 is enabled to dial the phone number of the help service telephony system 232, the session reference identifier (which may be formatted as a string of numerals) could be appended to the end of the phone number and separated by a “p” (e.g., a pause character recognized as such by the telephony module 250). The help service telephony system 232 can be enabled to recognize the session identifier 249 appended to the phone number, and route the call to a selected agent.

The help service telephony system 232 can cause the workstation 234 to automatically download the terminal's data 247 from the database 248 based on the detected session reference identifier 249. This device data 247 may be made available to the agent before or during the help service call. The agent will thus have the data 247 readily available to solve the user's problem.

In another example of automatically obtaining the user data 247 for the help service agent, the help service telephony system 232 may be enabled to detect the Mobile Station Integrated Services Digital Network number (MSISDN) 252 associated with the terminal 202. An MSISDN 252 is a number used to access a mobile subscriber, and is typically formed using a country code, a national destination code and a subscriber number. A receiving entity, such as the help service telephony system 232, can determine a caller's MSISDN 252 using a Caller Line Identification (CLI) service. Generally, CLI is a service supplied by many phone providers, where the phone number is transmitted when the phone call is made. With CLI-equipped receiving equipment, the help service telephony system 232 can determine the MSISDN 252 of the caller before routing the call.

When the help service telephony system 232 determines the MSISDN 252 of the terminal 202, a query can be directed to the help center server 236 and/or database 248 to retrieve the user data 247 stored in relation to the service call. The MSISDN 252 may itself serve as the session reference identifier 249, or the MSISDN 252 may serve as a key to access the session reference identifier 249 from the database 248. In some situations, the database 248 may use a session reference identifier 249 that is different from the MSISDN 252, because the session reference identifier 249 should be unique to the database 248. Even though the MSISDN 252 is unique to the terminal 202, the terminal 202 may make several help queries over time, and thus would need a unique identifier for each query. However, where it may be assumed a short time elapses between the help request trigger and the phone call, the MSISDN may be suitable for a session reference identifier 249.

Once the help service telephony system 232 has determined the identity of the caller using the session reference identifier 249 and/or the MSISDN 252, the telephony system can signal this event to a help center workstation 234. The agent at the workstation 234 can automatically access the user data 247 via the database 248 in order to analyze the problem. The help agent may initiate voice communications with the terminal 202 immediately upon receipt of the signal, or may place the user on hold while analyzing the problem. The workstation 234 may include an integrated telephone device (e.g., modem) for talking with the user of the terminal 202. Alternatively, the agent may use a standard telephone unit that is synchronized with the workstation 234 via the help service telephony system 232.

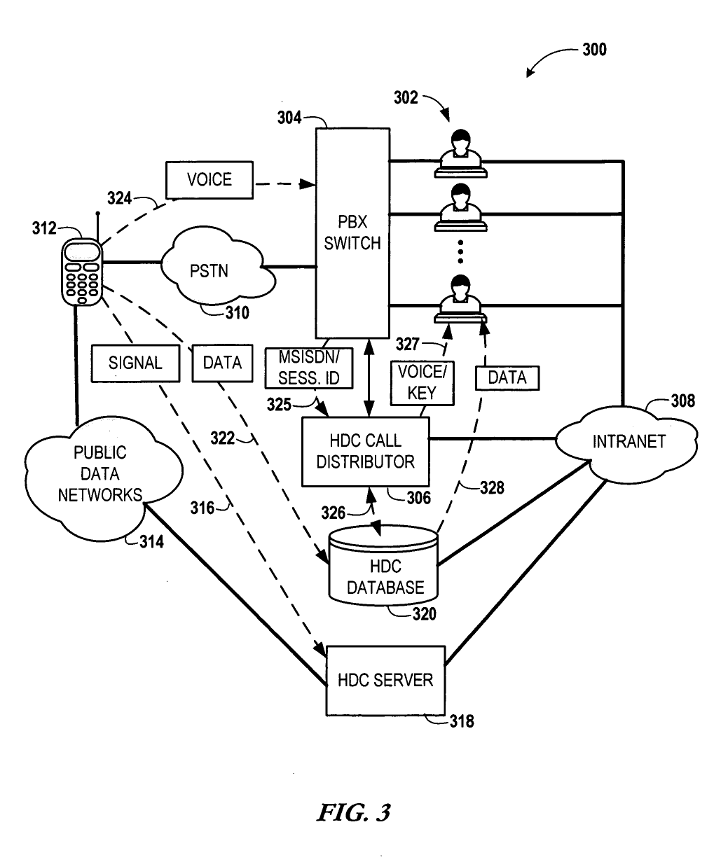

A more detailed example of a help service center according to an embodiment of the present invention is illustrated in FIG. 3. FIG. 3 is a block diagram showing a help service center 300 that is enabled to process help requests. The help service center 300 may include a plurality of agent workstations 302 that each include data processing and voice telephony capabilities. The voice traffic may be directed to individual workstations 302 via a Private Branch Exchange (PBX) 304. The PBX 304 includes a telephone switch that establishes voice-grade circuits to a telephone company central office. The PBX 304 may be able to handle any type of voice traffic technologies, including plain-old telephone service (POTS), Time-Division Multiplexing (TDM), Telephony Application Programming Interface (TAPI) VoIP, H.323, Session Initiation Protocol (SIP), etc.

The PBX 304 may include functional modules that provide service beyond telephone switching, such as directory services, call conferencing, interactive voice response, call queuing, etc. One such functional module is the help desk center (HDC) call distributor module 306. The HDC call distributor 306 interfaces with the PBX 304 and a local intranet 308 for matching help client data to incoming voice calls received via the telephony networks (e.g., the PSTN 310). The voice call and help client data may both originate at the same mobile device 312.

As described in more detail elsewhere herein, the mobile device 312 first signals via public data networks 314 that a help request is desired. This signal, represented by path 316, may be directed to an HDC server 318 in order to provide user/device data related to the help request. The HDC server 318 responds with a triggering message (not shown) that may include both a session reference identifier and a URL of a data upload entity. The user/device data is placed, either directly or indirectly, in an HDC database 320 as represented by path 322. The inserted data 322 is associated with a key that may include one or both of an MSISDN or session reference identifier generated by the database 320 or other network entity.

After the data is inserted 322 into the database 320, the user initiates a phone call with the help service center 300 as represented by path 324. The phone call 324 is received by the PBX 304, which extracts the database key used to reference the earlier data insertion 322. This extraction may involve determining the MSISDN of terminal using CLI or relate technologies, and/or may involve parsing additional digits dialed by the mobile device 312 after connecting to the PBX 304. These additional digits may represent any combination of the MSISDN or the session reference identifier.

Before the workstation 302 receives the call 324, the PBX 304 may pass the key (e.g., MSISDN, session reference identifier) to the call distributor module 306 as represented by path 325. The call distributor 306 may distribute the voice call along with the key to any available workstation 302, as represented by path 327. Alternatively, the call distributor 306 may first access the user data from the database, as indicated by path 326, before routing the call. This data access 326 may allow the call distributor 306 to determine the classification of the help request, thus allowing the call to be routed to a particular subset of the workstations 302 (e.g., to tech support as opposed to sales).

After the agents receive calls that were distributed 326 by the call distributor 306 and PBX switch 304, the agents may access the user data from the database 320 as represented by path 328. The user data may be displayed in user interfaces of the workstations 302 and be used to complete the help call. The workstations 302 may provide the ability to create a Web page or other document (e.g., email, embedded object, etc.) that describes the solution provided by the agent and can be used for future reference. This document can be placed on the HDC server 318 for access by the mobile device 312 via the public data networks 314. The document can also be sent to the mobile device 312, either directly (e.g., instant messaging, short message service) or indirectly (e.g., network storage, email server, etc.).

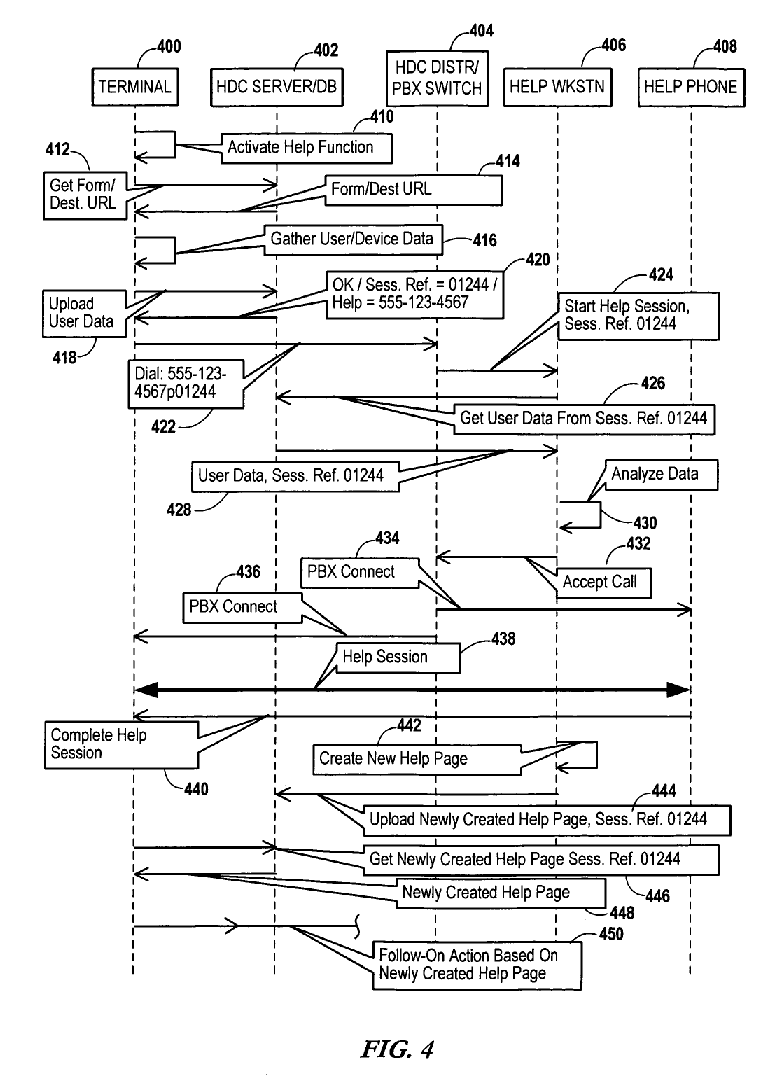

In reference now to FIG. 4, a sequence diagram shows an example sequence for providing help services using a session reference identifier in accordance with embodiments of the present invention. A user accesses a terminal 400 that may be capable of both voice and digital data communications. The terminal 400 is most commonly a mobile device, however, other devices may serve as the terminal 400. For example, a network-connected desktop computer with VoIP and/or a voice modem may be capable of providing the necessary terminal functions.

Other functional elements of the sequence diagram include an HDC server and database 402, an HDC distributor/PBX switch 404, a help desk workstation 406, and a help desk telephone 408. These functions of these elements and their equivalents are generally described in relation to FIGS. 1-3. The help session begins with the user activating 410 the help function at the terminal 400. This activation 410 may result in a local GUI element being displayed (e.g., a dialog or form), or may optionally result in the terminal 400 requesting and receiving a trigger/form 412, 414 from the HDC server 404. Receiving the trigger/form 414 may also involve retrieving a target URL, and/or session reference identifier used for submission of user/device data, as well as other data such as a help center phone number.

The help form 414 that is retrieved may include graphical elements (e.g., combo boxes, radio boxes, text fields, menus) that allow the user to define the classification of the problem and provide some details of the problem, including a plain language description of the issue to be resolved. Depending on the type of problem, the form 412 may include fields that will be helpful to an agent. For example, if the problem relates to software, the user might describe exactly what they were doing when the problem occurred, whether the problem is repeatable, etc.

In response to the trigger/form 412, the terminal 400 gathers 416 the necessary data required to fill out the help request. This gathering 416 may involve any combination of system calls, local database access, user prompts, and any other programmatic methods. The contents of the data to be gathered 416 may be defined in the type of request activated 410, and/or may be defined in the response 414 from the HDC server 402. The gathered data is then uploaded 418 to the HDC server/database 402. In response, the HDC server/database 402 provides an acknowledgement 420 that may include the phone number of the help service center, and optionally includes the session reference identifier if not provided in a previous step. If the help service phone number was provided to the terminal 400 in the help form/trigger 412, the HDC server/database 402 may provide an update to that phone number in the acknowledgement 420, based on the additional data received in the upload 418.

The acknowledgement 420 proved by the server may include user input elements that allow the user to add or modify help-related data that was previously entered in the help form 412. The acknowledgement 420 may display the device data along with the help query and related troubleshooting inputs. In some setups, the help form 412 may be a simple message that provides a URL and reference identifier, and the user does not input any data in the help form 412. In such a case, the user may be able to add query text and input other help request data to the acknowledgement 420, and then submit (not shown) the acknowledgement form to the server 402.

After the user receives the acknowledgement, the user may then automatically or manually connect 422 to the PBX switch 404. In the illustrated example, the connection 422 to the PBX switch 404 involves 404 dialing the help service center phone number, pausing (as indicated by the “p” character) and then dialing the session reference identifier. The PBX switch/HDC distributor 404 parses the extra digits, recognizes digits as a session reference identifier, and signals 424 to the help workstation 406 the existence of an incoming help request. This signal 424 may include the session reference identifier, which the workstation may use to retrieve 426, 428 the user data from the HDC server/database 402.

The help agent can use the data retrieved 428 from the HDC server/database 402 to analyze 430 the user's problem during or before taking the user's call. In this example, the user is placed on hold while the help agent analyzes 430 the data. Thereafter, the help agent accepts 432 the call via the workstation 406, although the call could be also accepted via the telephone 408. The PBX switch 404 then connects 434, 436 the terminal 400 to the telephone 408, and the help session 438 commences.

During the help session 438, the help agent generally talks to and listens to the user to solve the problem. Where the terminal 400 supports simultaneous voice and data transmissions, help agent may initiate data interactions between the terminal 400 and the workstation 406 and/or server 402 while talking. For example, the help agent may start a device management session with the terminal 400. Device management (DM) refers to over-the-air, network configuration of devices. A DM server (not shown) may allow the help agent to remotely perform such tasks as automated device diagnosis, repair of settings, and firmware update.

After the help session is completed 440, the agent may create a Web page 442 or other document at the help workstation 406 and upload 444 the document to the HDC server 402. This document may act as a record of the help session, and/or may contain data for use by the terminal's owner to solve the problem. In the latter case, the user may download 446, 448 the document to the terminal 400 for viewing or to save to persistent storage. The document may contain other data (e.g., hyperlinks) that allow the use to perform follow-on actions 450, such as downloading updates, running diagnostic software, etc. For example, the user and/or help agent may be able to create a Frequently Asked Questions (FAQ) Web page entry based on successful resolution of the problem. The follow-on action 450 may involve the user and/or agent navigating to a Web page that lists the problem and various device data pertinent to the problem, with a blank text entry panel in which to type the solution to the problem.

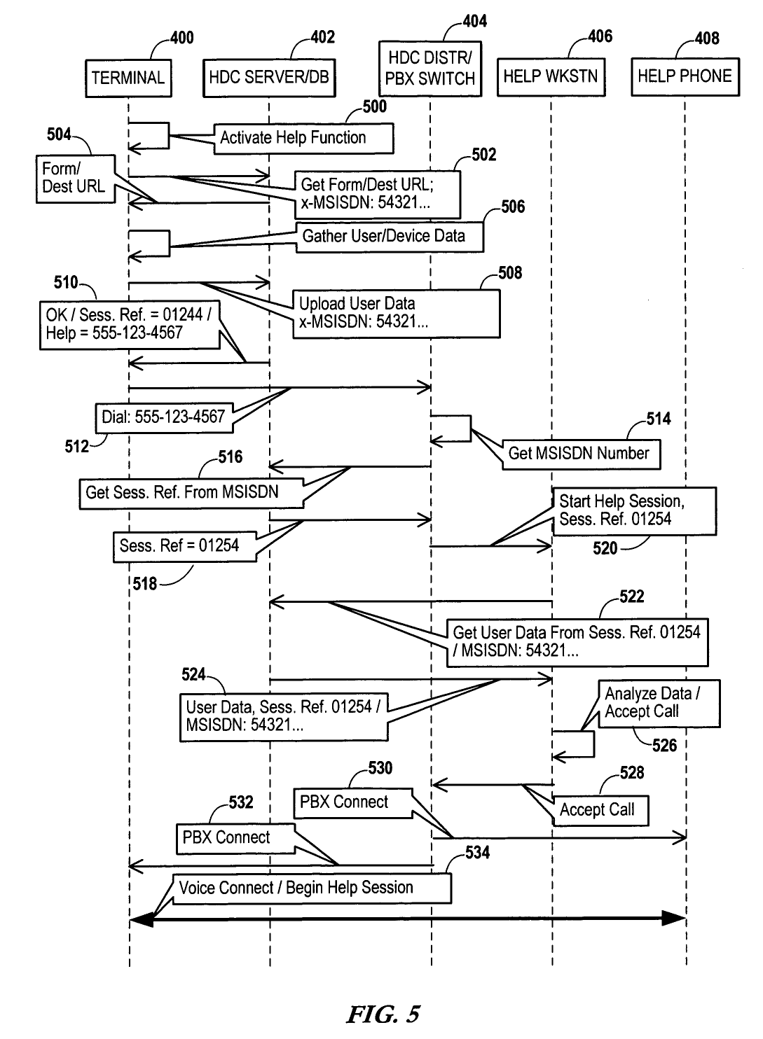

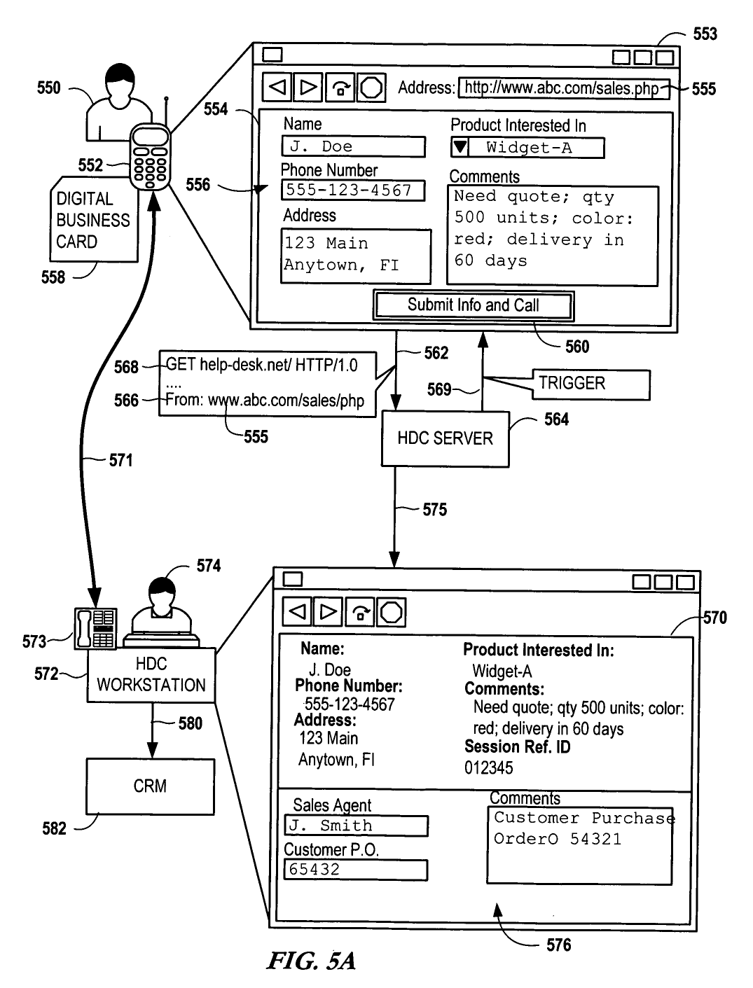

An alternate scenario to the one shown in FIG. 4 is illustrated in the sequence diagram of FIG. 5. In FIG. 5, a sequence is shown for providing help services using an MSISDN identifier in accordance with embodiments of the present invention. The functional components of the sequence diagram retain the same reference numbers used in FIG. 4, and similarly include a terminal 400, an HDC server/database 402, an HDC distributor/PBX switch 404, a help desk workstation 406, and a help desk telephone 408.

In this example, the user activates 500 the help function as previously described. In response, the terminal 400 downloads 502, 504 triggering data such as a help form, session identifier, URL, telephone number, etc. In this case, the trigger request 502 is an HTTP method (e.g., GET) that includes a specially crafted HTTP header, x-MSISDN. The header entry allows the HDC server/database 402 to determine the MSISDN of the terminal 400. As before, the terminal 400 gathers 506 the necessary data, and submits 508 this data to the HDC server/database 402. The data submission 508 may be an HTTP GET or POST method, and the x-MSISDN header may again be utilized.

In response to the data submission 508, the HDC server/database 402 responds with an acknowledgement 510 that may include a session reference identifier and a help service center phone number. Thereafter, the terminal 400 connects 512 to the PBX switch using only the telephone number of the help service center. The HDC distributor/PBX switch 404 receives the call and determine 514 the MSISDN of the terminal 400, such as by utilizing a CLI utility.

Once the HDC distributor/PBX switch 404 has determined 514 the MSISDN of the calling terminal 400, the HDC distributor/PBX switch 404 may optionally query 516 the HDC server/database 402 in order to determine a session reference identifier associated with the MSISDN. The HDC server/database 402 may have multiple reference identifiers associated with any given MSISDN. If so, the HDC server/database 402 may use some algorithm for choosing the correct identifier, such as choosing the identifier associated with the most recent, non-completed help request. The detected reference identifier is then sent 518 to the HDC distributor/PBX switch 404, which can thereafter notify 520 the help center workstation 406.

It will be appreciated that the query and response 516, 518 using the MSISDN may be performed by the workstation 406 instead of the HDC distributor/PBX switch 404. In that case, the notification 520 to the workstation 406 may only contain the MSISDN. Thereafter, the workstation 406 could obtain the session reference identifier and download 522, 524 the user data. The system may also be configured so that the session reference identifier is not required at all, such that downloading 522, 524 of the user data is accomplished using the MSISDN.

Once the workstation 406 has downloaded the user data 522, 524 the help session can commence substantially as described in relation to FIG. 4, including analysis 526, acceptance of the call 528, establishment of the voice connection 530, 532, and commencement of the help session 534. Although the above procedure may be used where the terminal 400 connects to the PBX switch 404 via the PSTN, modifications to the illustrated procedure may be implemented where the voice connection uses other voice networks, such as cellular phone system core networks or the Internet. Using these latter networks, additional or alternate data besides the MSISDN may be passed during the connection 512. For example, variables such as IMEI, MAC addresses, IP addresses, peripheral device identifiers (e.g., smart cards), private/public crypto keys, or any other data may be used in place of the MSISDN to match the identity of the incoming caller with the data previously stored in the HDC server/database 402.

It will be appreciated by those skilled in the art that the present invention is independent of any particular sequence of interactions as shown in FIGS. 4 and 5. In particular, where the mobile device is capable of simultaneous voice and data communications, some sequences may be performed simultaneously. For example, in FIG. 5 the voice connection 534 may be established prior to activating the help function 500 and performing subsequent actions.

Additionally, the sequences shown in FIGS. 4 and 5 may provide help services according to the present invention without performing all of the indicated steps. For example, there may be cases where no voice connection (e.g., 534) is required at all. In those cases, the data upload (e.g., 508) may automatically result in a customized help page being provided to the terminal (e.g., 446, 448). Based on the contents of the help page, the user may or may not need to talk to a help agent. Even if the user still needs to talk to the help agent thereafter, the user will be better educated about the problem by first viewing the help page. Similarly, the help agent can proceed more quickly to resolve to problem because, in addition to the agent having access to the uploaded device data (e.g., 508), the user has already eliminated some possibilities using self help.

The help desk scenarios described above may be useful in any sort of customer service enterprise. One customer service activity that may benefit from these types of help services is sales activity. In reference now to FIG. 5A, an example customer relations transaction according to embodiments of the present invention is illustrated. A user 550 has a terminal 552 with a browser 553 that is capable of Web browsing. The user 550 accesses a sales Web page 554 via a URL 555. The Web page 554 has fillable fields 556 that relate to user and product query data. The fields 556 may be filled both automatically (e.g., via a digital business card 558 stored on the terminal) or manually (e.g. via a keypad). The Web page 554 has an activation element 560, here represented as a button labeled “Submit Info and Call.”

The user 550 activates the activation element 560 when ready to initiate the transaction. The data contained in the fields 556 may be uploaded with a command 562 to an HDC server 564. Here, the command 562 is an HTTP GET, although other commands such as HTTP POST may be used. The command 562 includes the URL 555 of the Web page located in an HTTP header 566. The URL 555 may be embedded elsewhere in the command 562, such as in the command line 568. Note that the URL of the HDC server 564 as shown in the command line 568 may be different than the URL 555 of the Web page 554.

In response to the command 562, the terminal 552 receives a trigger 569 that may include data such as a session reference, a sales telephone number, etc. A telephone call 571 can thereafter be commenced between the terminal 552 and a telephone 573 of a sales agent 574. After the command 562 is executed, a help page 570 is formed at the HDC server 564 based on the user's Web page 554. The help page 570 can be retrieved 575 from the HDC server 564 at an HDC workstation 572. The sales agent 574 views the help page 570 at the workstation 572. The help page 570 may include additional fields 576 that may be used by the sales agent 574. The sales agent 574 can continue manipulating the help page 570 (e.g., adding data to the fields 576) during the call 571. At some point during or after the call 571, the sales agent 547 can submit 580 the completed help page 570 to the company's Customer Relations Management (CRM) system 582 or related data processing arrangement.

Variations may be possible on the help scenario described in relation to FIG. 5A. For example, after the user's Web page fields 556 have been filled, the activation component 560 causes the GET command 562 to get the trigger 569, but to do so without submitting the data contained in the fields 556. After receiving the trigger 569, the terminal software (e.g., help application 240 in FIG. 2) retrieves the Web page 554 from the browser memory buffer with the temporary fill-in parameters. After the trigger 569 is received, the Web page 554 is then uploaded to the HDC server 564, including the data contained in the fields 556. The call 571 is connected using a sales agent phone number that is determined based on device data and the Web page data submitted after the trigger 569. The sales agent 574 may then access an exact duplicate of the Web page 554 the user 550 saw. The sales agent 574 may use this duplicate page as input to another program, such as the CRM system 582.

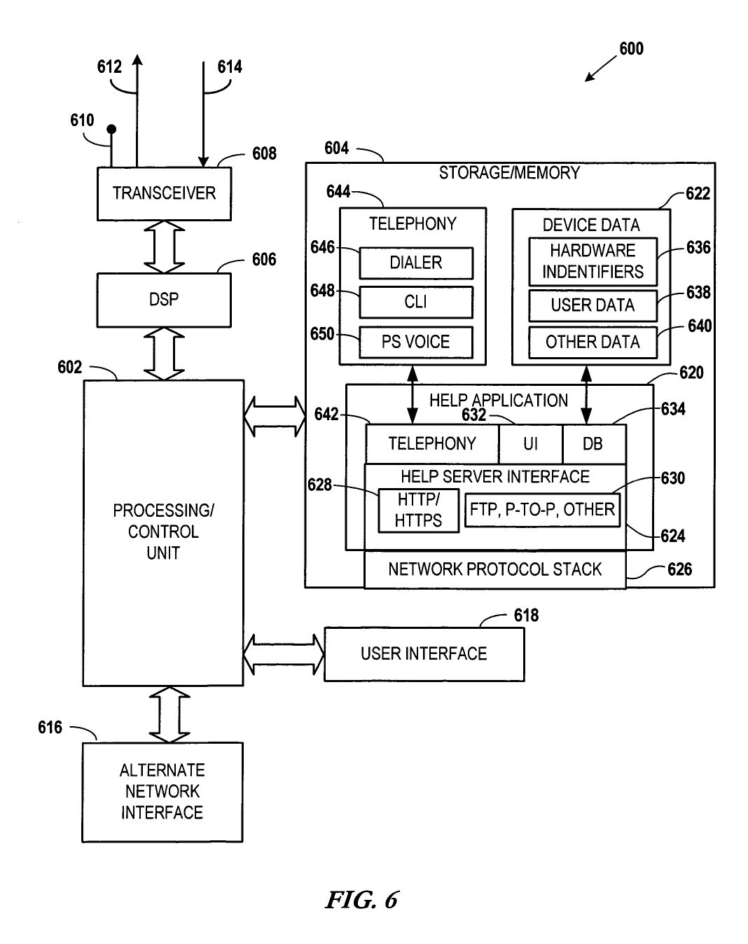

Many types of apparatuses may be configured to perform roles as terminals for obtaining help service. Mobile devices are particularly well suited to this task, as they can often support both voice and data communications. In FIG. 6, an example mobile computing arrangement 600 is illustrated that is capable of carrying out operations in accordance with embodiments of the invention. Those skilled in the art will appreciate that the exemplary mobile computing arrangement 600 is merely representative of general functions that may be associated with such mobile devices, and also that landline computing systems similarly include computing circuitry to perform such operations.

The illustrated mobile computing arrangement 600 may suitable at least for initiating help transactions via a data network. The mobile computing arrangement 600 includes a processing/control unit 602, such as a microprocessor, reduced instruction set computer (RISC), or other central processing module. The processing unit 602 need not be a single device, and may include one or more processors. For example, the processing unit may include a master processor and associated slave processors coupled to communicate with the master processor.

The processing unit 602 controls the basic functions of the arrangement 600. Those functions associated may be included as instructions stored in a program storage/memory 604. In one embodiment of the invention, the program modules associated with the storage/memory 604 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 600 via data signals, such as being downloaded electronically via one or more networks, such as the Internet and an intermediate wireless network(s).

The program storage/memory 604 may also include operating systems for carrying out functions and applications associated with functions on the mobile computing arrangement 600. The program storage 604 may include one or more of read-only memory (ROM), flash ROM, programmable and/or erasable ROM, random access memory (RAM), subscriber interface module (SIM), wireless interface module (WIM), smart card, hard drive, or other removable memory device.

The mobile computing arrangement 600 includes hardware and software components coupled to the processing/control unit 602 for performing network data exchanges. The mobile computing arrangement 600 may include multiple network interfaces for maintaining any combination of wired or wireless data connections. In particular, the illustrated mobile computing arrangement 600 includes wireless data transmission circuitry for performing network data exchanges.

This wireless circuitry includes a digital signal processor (DSP) 606 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 608, generally coupled to an antenna 610, transmits the outgoing radio signals 612 and receives the incoming radio signals 614 associated with the wireless device.

The mobile computing arrangement 600 may also include an alternate network interface 616 coupled to the processing/control unit 602. The alternate interface 616 may include the ability to communicate on proximity networks via wired and/or wireless data transmission mediums. The alternate interface 616 may include the ability to communicate using Bluetooth, 802.11 Wi-Fi, Ethernet, IRDA, and related networking technologies. The processor 602 is also coupled to user-interface 618 elements associated with the mobile terminal. The user-interface 618 of the mobile terminal may include, for example, a display such as a liquid crystal display, a keypad, speaker, microphone, etc. These and other user-interface components are coupled to the processor 602 as is known in the art. Other user-interface mechanisms may be employed, such as voice commands, switches, touch pad/screen, graphical user interface using a pointing device, trackball, joystick, or any other user interface mechanism.

The storage/memory 604 of the mobile computing arrangement 600 may include software modules for providing network services via any of the network interfaces (e.g., transceiver 608 and alternate interface 616). In particular, the storage/memory 604 includes a help application 620 that provides the ability to deliver device data 622 via one or more communication interfaces 608, 616 in conjunction with a help service request. Typically, the help application 620 includes a help server interface module 624 that is capable of performing exchanges with a help center server (e.g., HDC server 134 in FIG. 1) via an external data connection. The help server interface module 624 typically interfaces with a network protocol stack 626 that may include multiple protocol stacks (e.g., TCP/IP, UDP/IP). The network protocol stack 626 may be provided by any combination of the user software, operating systems, drivers, and/or hardware components.

The help server interface module 624 may have the ability to communicate with various standard or non-standard protocols used by the help center server. The help server interface module 624 may include sub-modules capable of communicating via HTTP/HTTPS 628, or other protocols such as peer-to-peer, FTP, etc., as indicated by sub-module 630. These sub-modules 628, 630 may be built in to the help server application 620, or may be provided by external libraries or applications. For example, the help server application 620 may be provided as a browser plug-in, and the browser itself contains the logic to communicate via HTTP/HTTPS, FTP, and the like.

The help application 620 includes a UI module 632 that provides user feedback and accepts user inputs via the hardware UI interface 618. The UI module 632 may be used for configuration, software installation/removal, generating prompts and verification during help requests, accepting user data via forms or other UI components, etc. The UI 632 may include custom dialogs/windows, or may use another application such as a browser for display of input/output elements by using specially formed HTML documents.

A database module 634 allows the help application 620 to query and store device data 622 accessible on the mobile computing arrangement 600. The device data 622 may be stored in persistent storage, may be made available by accessing hardware registers, or may be dynamically generated by user inputs or processor algorithms. Any type of data useful to the particular help function may be included with the device data 622, including hardware identifiers 636, user data 638, and any other data 640.

The help application 620 may include a telephony interface 642 that has the ability to interact with telephony functions 644 of the mobile computing arrangement 600. The help application 620 may utilize such telephony functions 644, such as a dialer 646 for dialing out to help centers using specially crafted phone numbers that include session reference identifiers. The help application 620 may also detect and/or utilize a CLI function 648 that can be used to associate an MSISDN with a help session. If the mobile computing arrangement 600 is capable of communicating via packet switched networks (e.g., VoIP), then the telephony interface 642 may be enabled to communicate using packet switched voice functions 650. In such a case, the help application 620 may be able to pass along session identifiers, device data 622, or other relevant data using packet-switched signaling and voice protocols (e.g., SIP, H.323, etc.).

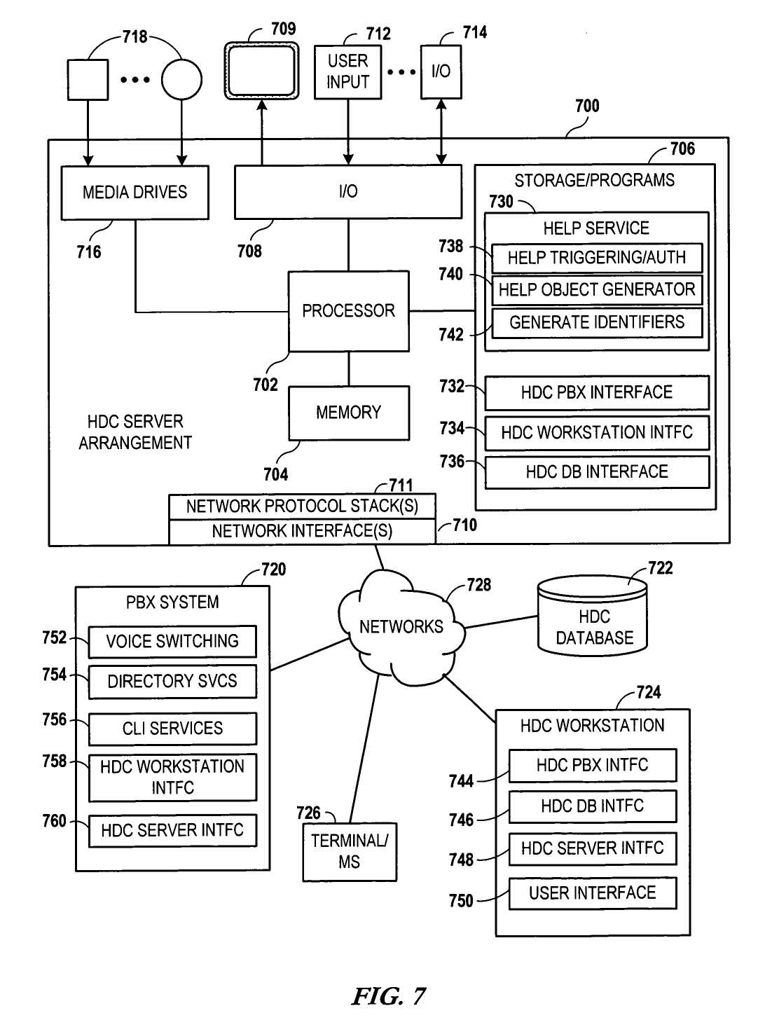

A mobile computing arrangement 600 according the present invention utilizes network nodes to store device data 622 related to help services. This data 622 may be transferred to one or more servers and/or databases for at least temporary storage. The data 622 can thereafter be accessed by a help agent while processing a help service call. In reference now to FIG. 7, a block diagram shows a representative computing implementation of a help center server arrangement 700 capable of carrying out operations in accordance with the invention.

The help center server arrangement 700 includes a central processor 702, which may be coupled to memory 704 and data storage 706. The processor 702 carries out a variety of standard computing functions as is known in the art, as dictated by software and/or firmware instructions. The storage 706 may represent firmware, hard-drive storage, etc. The storage 706 may also represent other types of storage media to store programs, such as programmable ROM (PROM), erasable PROM (EPROM), etc.

The processor 702 may communicate with other internal and external components through input/output (I/O) circuitry 708. The help center server arrangement 700 may therefore be coupled to a display 709, which may be any type of display or presentation screen such as LCD displays, plasma display, cathode ray tubes (CRT), etc. A user input interface 712 is provided, including one or more user interface mechanisms such as a mouse, keyboard, microphone, touch pad, touch screen, voice-recognition system, etc. Any other I/O devices 714 may be coupled to the help center server arrangement 700 as well.

The help center server arrangement 700 may also include one or more media drive devices 716, including hard and floppy disk drives, CD-ROM drives, DVD drives, and other hardware capable of reading and/or storing information. In one embodiment, software for carrying out the data insertion operations in accordance with the present invention may be stored and distributed on CD-ROM, diskette or other form of media capable of portably storing information, as represented by media devices 718. These storage media may be inserted into, and read by, the media drive devices 716. Such software may also be transmitted to the help center server arrangement 700 via data signals, such as being downloaded electronically via one or more network interfaces 710.

The help center server arrangement 700 may be coupled to other computing devices, such as the PBX system 720, the HDC database 722, the HDC workstation 724 and/or mobile terminals 726, via the network interface 710. The network interface 710 may be coupled to one or more networks 728 that allow ultimate connection to the various landline and/or mobile devices. The network interface 710 is associated with one or more network protocol stacks 711 that handle transactions using standard and customized network protocols. The network protocol stacks 711 may be implemented using any combination of hardware and software, and is generally implemented as a core service of the operating system.

In accordance with one embodiment of the invention, the storage 706, memory 704, and/or media devices 708 store the various programs and data used in connection with the present invention. In the illustrated embodiment, the data storage 706 is shown storing various program modules operable in connection with the processor 702. In particular, the data storage 706 may contain modules that perform the functions of help server 730, HDC PBX interface 732, HDC workstation interface 734, and HDC database interface 736.

The help service module 730 contains sub-modules that handle help service transactions such as the initial triggering/authentication sub-module 738. The triggering/authentication sub-module 738 may include a daemon that listens for incoming help requests from a terminal 726. The triggering/authentication sub-module 738 may provide mechanisms for authenticating the identity of the terminal (e.g., checking IMEI, password authentication) and for allowing the terminal 726 to authenticate the server's identity (e.g., PKI certificates).

In response to help requests received via the triggering/authentication sub-module 738, the help service module 730 may provide data to the originator, including a session reference identifier, a URL for submitting data, telephone numbers, and help objects used at the terminal 726 for obtaining information. The help objects may be provided via a help object generator sub-module 740. The help object generator 740 may provide basic HTML forms that allow the user to manually enter some data. In other arrangements, the help object generator 740 may provide executable code (e.g., Java applet, ActiveX control, etc.) that operates with terminal software to automatically extract user/device data.

The help service module 730 may utilize an identifier generator module 742 to associate the device data with an index for use with the HDC database 722. The identifier generator 742 may use an MSISDN provided by the terminal as an index, and/or may use a unique session reference identifier either generated internally or via the HDC database 722. The data gathered by the terminal 726 can be gathered by the help service module 730 and placed in the HDC database 722 via the HDC database interface 736.

Generally, the terminal data placed in the HDC database 722 will later be accessed by an HDC workstation 724. This access may occur directly between the HDC workstation 724 and the HDC database 722, or the HDC workstation 724 may access the data via the HDC workstation interface 734 of the server arrangement 700. Similarly, the PBX system 720 may receive data identifiers from incoming help calls. The PBX system 720 may verify these identifiers directly at the HDC database 722, or indirectly via the PBX interface 732 of the server arrangement 700.

The HDC workstation 724 may contain hardware components similar to those described in relation to the help center server arrangement 700. In addition, the HDC workstation 724 may also contain a PBX interface 744 for receiving indications of incoming calls from the PBX system 720. The PBX system 720 may send to the PBX interface 744 of the HDC workstation 724 an identifier used for accessing data associated with the incoming calls. Data associated with these incoming help service calls may be extracted at the HDC workstation 724 via an HDC database interface 746 and/or an HDC server interface 748. The HDC workstation 724 may contain a user interface 750 that is capable of displaying the user data.

After the help service call is completed, the help agent may use the user interface 750 to create a document that is accessible by the terminal 726. This document may be sent from the HDC server interface 748 of HDC workstation 724 to the HDC server arrangement 700, where it is made available to the terminal 726 via the network 728. Additionally, the workstation 724 may utilize the HDC database interface 746 to modify status (e.g., closed, pending) on the user data stored in the HDC database 722 after completion of a call.

The PBX system 720 generally identifies and routes incoming help calls. A voice switching module 752 receives incoming calls and performs voice circuit switching on those calls to local PBX circuits. A directory services module 754 generally allows routing of calls based on touch-tone or dial inputs to PBX extensions. The directory services module 754 (or other functional module of the PBX system 720) may be adapted to receive help session reference identifiers that are appended to the phone number of the main incoming register of the PBX system 720. The PBX system 720 may also include a CLI services module 756 that allows identifying the MSISDN associated with incoming help calls. The MSISDN may also be used, directly or indirectly, to obtain help session reference identifiers.

When the PBX system 720 has determined a help session reference identifier, telephonic communications of the help session may be directed to a help agent via the voice switching module 752, and the reference identifier and/or associated data may directed to an HDC workstation 724 via an HDC workstation interface 758. Generally, the HDC workstation interface 758 is synchronized with the voice switching module 752 to allow the target HDC workstation 724 to simultaneously access both the voice traffic and device data associated with the calling terminal 726. Finally, the PBX system 720 may include an HDC server interface 760 for logging incoming help calls with the HDC server 700. This may be useful, for example, for identifying calls that were received by the PBX system 720 but were never serviced by an agent. This situation may occur where the user hung up before completing the call or where the call was dropped before connecting to an agent.

The computing arrangements 700, 720, 724 of FIG. 7 are provided as representative examples of computing environments in which the principles of the present invention may be applied. From the description provided herein, those skilled in the art will appreciate that the present invention is equally applicable in a variety of other currently known and future mobile and landline computing environments. Thus, the present invention is applicable in any known computing structure where data may be communicated via a network.

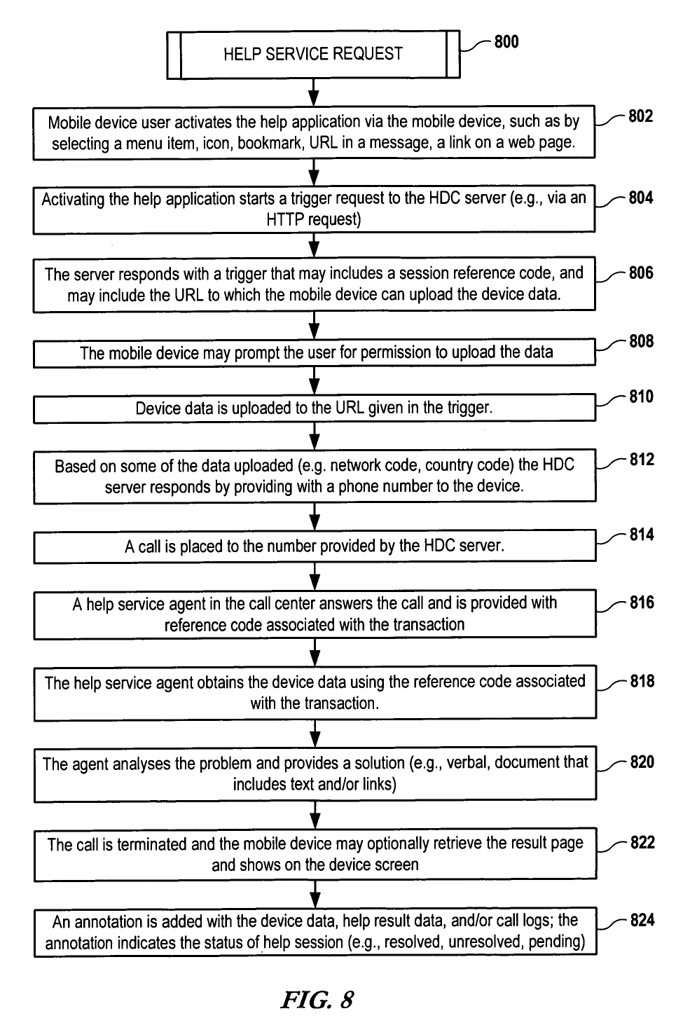

Turning now to FIG. 8, a flowchart illustrates a procedure 800 for providing assistance to a user of a mobile device capable of being coupled to voice and data networks. First, the mobile device user activates (802) the help application via the mobile device. The activation (802) may include selecting a menu item, icon, link, bookmark, etc. The activation (802) causes a request (804) to be sent to an HDC server. The request (804) is for a trigger that will involve the sending of device data to the HDC server. The device data may be any combination of hardware, software, and user data, and is included at least in part to assist a help agent in fulfilling the help request.

The server responds with a trigger (806) that includes a session reference code associated with the device data. The trigger (806) may also include a URL to which the mobile device may upload the data, although the URL may be provided by other mechanisms. The mobile device may prompt (808) the user to request permission to upload the device data, after which the device data is uploaded (810) to the URL provided by the trigger or other means. The URL may point to the HDC server, and HDC database, or any other appropriate network node.

Based on the uploaded data, the HDC server may respond (812) with a phone number for use in starting a telephone call to the help center. This response (812) may involve just displaying the number to the user, or may involve automatically setting up and/or initiating a phone call. In either event, the phone call is placed (814) to the help center.

A help service agent can answer (816) the phone call and be provided with the session reference code that was provided in the trigger (806). The session reference code may be provided manually by the mobile device user, or may be provided automatically by the help center telephone exchange system. An example of the latter is where the session reference code is appended to the help center phone number, and/or where the telephone exchange determines an MSISDN of the mobile device, and uses the MSISDN to derive the session reference code.

The help agent is uses the session reference code to obtain (818) the previously stored device data. The data may be used to analyze and resolve (820) the help query. The resolution (820) may involve any combination of verbal responses and network accessible documents. The call is then terminated (822) and the user may access the resolution document should one have been created. Finally, the agent will annotate (824) the device data, help result data, and/or call logs. The annotation may indicate the status of the help session (e.g., resolved, unresolved, pending).

Hardware, firmware, software or a combination thereof may be used to perform the various functions and operations described herein. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A method of providing assistance to a user of a mobile device capable of being coupled to a network, comprising:
sending a signal from the mobile device to a help service computing arrangement via the network to initiate a help session;
sending, via the network, device-specific data of the mobile device targeted for a help database;
associating a session identifier with the device-specific data via the help service computing arrangement;
initiating a voice connection between the user and a help agent;
providing the session identifier to the help agent; and
accessing the device-specific data by the help agent from the help database using the session identifier for purposes of providing the assistance.

2. The method of claim 1, further comprising:
forming a network-accessible document by the help agent for purposes of providing the assistance; and
accessing the document by the mobile device via the network.

3. The method of claim 1, further comprising receiving at the mobile device a network location identifier sent by the help service computing arrangement via the network in response to the signal, and wherein sending the device-specific data to the help database comprises sending the device specific data to the network location identifier.

4. The method of claim 1, further comprising receiving at the mobile device the session reference identifier from the help service computing arrangement via the network in response to the signal.

5. The method of claim 1, further comprising receiving at the mobile device a data descriptor from the help service computing arrangement via the network in response to the signal, the data descriptor describing the device-specific data needed to provide the assistance.

6. The method of claim 1, wherein providing the session identifier to the help agent comprises appending the session identifier to a phone number used to initiate the voice connection.

7. The method of claim 1, wherein associating the session identifier with the device-specific data comprises associating a network address of the mobile device with the device specific data.

8. The method of claim 1, wherein associating the session identifier with the device-specific data comprises associating a Mobile Station Integrated Services Digital Network number (MSISDN) of the mobile device with the device specific data.

9. The method of claim 8, wherein providing the session identifier to the help agent comprises determining the MSISDN in conjunction with the voice connection between the user and the help agent.

10. The method of claim 9, wherein determining the MSISDN comprises determining the MSISDN using a caller line identification service.

11. The method of claim 10, wherein determining the MSISDN comprises appending the MSISDN to a phone number used to initiate the voice connection.

12. The method of claim 1, further comprising receiving at the mobile device a help service phone number from the help service computing arrangement via the network in response to sending the signal from the mobile device to the help service computing arrangement via the network.

13. The method of claim 12, further comprising receiving at the mobile device an update to the help service phone number from the help service computing arrangement via the network in response to sending the device-specific data of the mobile device targeted for the help database.

14. The method of claim 1, further comprising receiving at the mobile device a help service phone number from the help service computing arrangement via the network in response to sending the device-specific data of the mobile device targeted for the help database.

15. The method of claim 14, wherein initiating the voice connection between the user and the help agent further comprises automatically dialing the help service phone number via a processor of the mobile terminal to initiate the voice connection between the user and the help agent.

16. The method of claim 1, further comprising gathering the device-specific data via a Web page capable of being modified by the user.

17. The method of claim 16, wherein sending the device-specific data of the mobile device targeted for the help database comprises sending a duplicate of the Web page targeted for the help database.

18. The method of claim 16, wherein sending the signal from the mobile device to the help service computing arrangement comprises sending data derived from the Web page to the help service computing arrangement.

19. The method of claim 16, wherein sending the signal from the mobile device to the help service computing arrangement comprises sending a source URL of the Web page to the help service computing arrangement.

20. A data-processing arrangement, comprising:
a network interface capable of receiving data via a network;
a voice communications module capable of being coupled to a voice network;
a processor coupled to the network interface and the voice communications module; and
a memory coupled to the processor, the memory having a help application that causes the processor to,
send a signal to a help service computing arrangement via the network to initiate a help session;
send device-specific data of the data-processing arrangement targeted for a help database via the network;
receive a session identifier associated with the device-specific data from the help service computing arrangement;
initiate a voice connection with a help agent via the voice communications module; and
provide the session identifier to the help agent for purposes of retrieving the device-specific data from the help database to provide assistance to a user of the data processing arrangement.

21. The data-processing arrangement of claim 20, further comprising a database module that causes the processor to access the device-specific data; and
wherein the help application further causes the processor to obtain the device specific data from the database module before sending the device-specific data targeted for the help database.

22. The data-processing arrangement of claim 21, wherein help application further causes the processor to receive a data descriptor from the help service computing arrangement via the network in response to the signal, the data descriptor used by the help application to obtain the device-specific data from the database module.

23. The data-processing arrangement of claim 20, wherein the help application further causes the processor to receive a help service phone number from the help service computing arrangement via the network.

24. The data-processing arrangement of claim 23, further comprising a telephony connection module coupled to the voice communication module and the processor;
and wherein the help application further causes the telephony connection module to dial the help service phone number to initiate the voice connection with the help agent.

25. The data-processing arrangement of claim 24, wherein help application further causes the telephony connection module to dial the help service phone number appended with the session identifier to initiate the voice connection with the help agent.

26. The data-processing arrangement of claim 23, wherein the help application further causes the processor to receive the help service phone number from the help service computing arrangement via the network in response to the signal.

27. The data-processing arrangement of claim 26, wherein the help application further causes the processor to receive an update to the help service phone number from the help service computing arrangement via the network in response to sending the device-specific data of the mobile device targeted for the help database.

28. The data-processing arrangement of claim 23, wherein the help application further causes the processor to receive the help service phone number from the help service computing arrangement via the network in response to sending the device-specific data targeted for the help database.

29. The data-processing arrangement of claim 20, wherein the session identifier comprises a network address of the mobile device.

30. The data-processing arrangement of claim 20, wherein the session identifier comprises a Mobile Station Integrated Services Digital Network number (MSISDN) of the data-processing arrangement.

31. A processor-readable medium having instructions stored thereon which are executable by a data processing arrangement capable of being coupled to a network, the instructions executable by the data processing arrangement for performing steps comprising:
sending a signal to a help service computing arrangement via the network to initiate a help session;
sending device-specific data of the data-processing arrangement targeted for a help database via the network;
receiving a session identifier associated with the device-specific data from the help service computing arrangement;
initiating a voice connection with a help agent; and
providing the session identifier to the help agent purposes of retrieving the device-specific data from the help database to provide assistance to a user of the data processing arrangement.

32. A data-processing arrangement, comprising:
a network interface capable of communicating via a network;
a processor coupled to the network interface; and
a memory coupled to the processor, the memory having a help service module that causes the processor to,
receive a signal from a mobile device to initiate a help session via the network;
send a trigger to the mobile device in response to the signal, the trigger configured to cause the mobile device to send device-specific data of the mobile device to a help database via the network;
associate a session identifier with the device-specific data; and
facilitate access of the device-specific data from the help database using the session identifier for purposes of providing assistance to a help agent conducting a telephonic help session.

33. The data-processing arrangement of claim 32, wherein the help service module further causes the processor to,
receive a document formed by the help agent for purposes of providing the assistance; and
provide the document to the mobile device via the network.

34. The data-processing arrangement of claim 32, wherein the help service module further causes the processor to send a network location identifier to the mobile device via the network in response to the signal, wherein the network location identifier is used by the mobile device to send the device-specific data of the mobile device to the help database.

35. The data-processing arrangement of claim 32, wherein the help service module further causes the processor to send the session reference identifier to the mobile device via the network in response to the signal.

36. The data-processing arrangement of claim 32, wherein the help service module further causes the processor to send a data descriptor to the mobile device via the network in response to the signal, the data descriptor describing the device-specific data sent by the mobile device to the help database.

37. The data-processing arrangement of claim 32, wherein the session identifier comprises a network address of the mobile device.

38. The data-processing arrangement of claim 32, wherein the session identifier comprises a Mobile Station Integrated Services Digital Network number (MSISDN) of the mobile device.

39. The data-processing arrangement of claim 32, wherein the help service module further causes the processor to send a help service phone number to the mobile device via the network in response to receiving the signal from the mobile device.

40. The data-processing arrangement of claim 39, wherein the help service module further causes the processor to,
access the device-specific data from the help database;
determine an updated help service telephone number of the help agent based on the device-specific data; and
send the updated help service phone number to the mobile device via the network in response to the mobile device sending the device-specific to the help database.

41. The data-processing arrangement of claim 32, wherein the help service module further causes the processor to,
access the device-specific data from the help database;
determine a help service telephone number of the help agent based on the device-specific data; and
send a help service phone number to the mobile device via the network in response to the mobile device sending the device-specific data to the help database.

42. A processor-readable medium having instructions stored thereon which are executable by a data processing arrangement capable of being coupled to a network, the instructions executable by the data processing arrangement for performing steps comprising:
receiving signal from a mobile device to initiate a help session via the network;
sending a trigger to the mobile device in response to the signal, the trigger configured to cause the mobile device to send device-specific data of the mobile device to a help database via the network;
associating a session identifier with the device-specific data; and
facilitating access of the device-specific data from the help database using the session identifier for purposes of providing assistance to a help agent conducting a telephonic help session.

43. A system comprising:
means for sending a signal from a mobile device to a help service computing arrangement to initiate a help session;
means for sending device-specific data of the mobile device to a help database;
means for associating a session identifier with the device-specific data;
means for initiating a voice connection between the user and a help agent;
means for providing the session identifier to the help agent; and
means for accessing the device-specific data by the help agent using the session identifier for purposes of providing the assistance.
